(19) United States
(12) Patent Application Publication
(10) Pub. No.: US 2007/0037433 A1
(43) Pub. Date: Feb. 15, 2007

(54) Backshell device for a connector

(75) Inventor: Paula Marie Carnahan, Hemet, CA (US)

Correspondence Address: HOGAN & HARTSON L.L.P., 1999 AVENUE OF THE STARS, SUITE 1400, LOS ANGELES, CA, 90067, US

(73) Assignee: DEUTSCH ENGINEERED CONNECTING DEVICES

(21) Appl. No.: 11/387,149

(22) Filed: Mar. 21, 2006

Related U.S. Application Data
(60) Provisional application No. 60/707,321, filed on Aug. 10, 2005.

(51) Int. Cl. H01R 13/627

(52) U.S. Cl. 439/352

(57) ABSTRACT

A backshell device for a connector includes a mounting section coupled to a portion of the connector. A removable extension section extends from the mounting section and is attached to the mounting section via separation features. A securing member is positioned around the mounting section for securing the mounting section to the connector.

### RELATED APPLICATION

This application claims priority under 35 U.S.C. § 119 to U.S. Provisional Application Ser. No. 60/707,321, filed Aug. 10, 2005, the content of which is incorporated herein by reference in its entirety.

### BACKGROUND OF THE INVENTION

1. Field of the Invention

The present invention relates to a backshell device for a connector.

2. Description of Related Art

Conventional backshell devices provide a rigid and secure connection of a wiring harness to an electrical connector. Due to concerns for material strength, many conventional backshell devices are formed of steel and are, sometimes, thick and/or heavy.

In aircraft and aerospace applications, it is desirable to have lightweight electrical and mechanical components. To reduce weight, some backshell devices are formed of lightweight materials, which can often be more expensive than using steel. Typically, these conventional lightweight backshell devices are still too thick and heavy because lightweight materials may require a larger footprint to provide a sizable strength similar to steel.

Moreover, conventional backshell devices often require complete removal of the wiring harness if maintenance requires replacement or if addition of a backshell device to a connector, that was not originally installed with a backshell device, is required. The removal of the wiring harness typically increases labor costs.

### SUMMARY OF THE INVENTION

The present invention is directed to a backshell device for a connector, such as, for example, an electrical connector.

In one embodiment, the backshell device includes a mounting section coupled to a portion of the connector. A removable extension section extends from the mounting section and is attached to the mounting section via one or more separation features. A securing member is positioned around the mounting section for securing the mounting section to the connector.

The connector includes a housing having a receiving section that extends therefrom. The mounting section of the backshell device couples to the receiving section of the connector. The securing member is positioned around the mounting section of the backshell device and the receiving section of the connector to secure the backshell device to the connector.

In one aspect, the mounting section includes one or more anti-rotation features that protrude from an inner surface of the mounting section. In another aspect, the receiving section of the connector may include a second recessed groove adjacent to the first recessed groove that couples with the anti-rotation features of the mounting section of the backshell device to thereby inhibit rotation of the backshell device with respect to the connector.

The removable extension section is separated from the mounting section by cutting the separation features. In general, a portion of the backshell device can be removed when the removable extension section is separated from the mounting section. For example, 65% of the backshell device can be removed when the removable extension section is separated from the mounting section.

The connector includes a wiring harness that extends from the receiving section of the housing. In one aspect, the wiring harness is secured to the removable extension section of the backshell device via at least one tie wrap to thereby provide strain relief to the wiring harness. In another aspect, the wiring harness includes an overbraid that shields the wiring harness.

In general, a portion of the removable extension section extends from the mounting section at an angle between 0° and 90°. In one preferred example, a portion of the removable extension section may extend from the mounting section at an angle of approximately 45°. Alternately, in another preferred example, a portion of the removable extension section extends from the mounting section at an angle of approximately 90°. In another aspect, the removable extension section includes a selectable pivot feature that allows a portion of the removable extension section to pivot at an angle between 0° and 90°.

In another embodiment, a backshell assembly includes a connector and a backshell device having a mounting section that couples to a portion of the connector. The backshell device includes a removable extension section that extends from the mounting section and is attached to the mounting section via separation features. A securing member is positioned around the mounting section for securing the mounting section to the connector.

Other features and advantages of the invention will be apparent from the following detailed description, taken in conjunction with the accompanying drawings which illustrate, by way of example, various features of embodiments of the invention.

### BRIEF DESCRIPTION OF THE DRAWINGS

FIG. 1A is a perspective view of a backshell device coupled to a connector.

FIG. 1B is a perspective view of backshell device coupled to connector with a portion removed.

FIG. 2 is a perspective view of backshell device coupled to connector 102 via securing member and a threaded interconnection.

FIG. 3 is a perspective view of backshell device having a plurality of first anti-rotation features.

FIG. 4 is a perspective view of connector having a plurality of second anti-rotation features.

FIGS. 5A and 5B are perspective views of backshell device having an angled removable extension section.

FIG. 6 is a perspective view of backshell device having multi-exit features.

FIGS. 7A-7C are perspective views of backshell device having removable extension section with a pivotable portion.

FIG. 8 is a perspective view of one example of an application of backshell device and connector of the present invention.

### DETAILED DESCRIPTION OF THE INVENTION

Reference will now be made to the drawings wherein like numerals refer to like parts throughout.

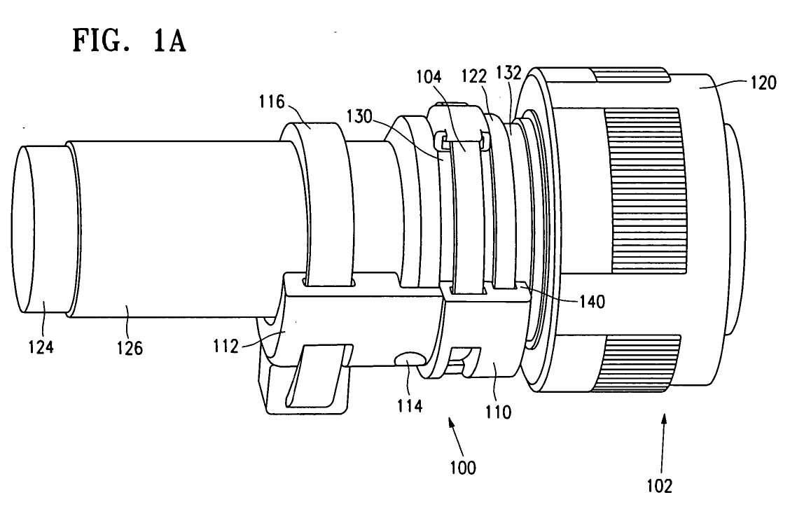

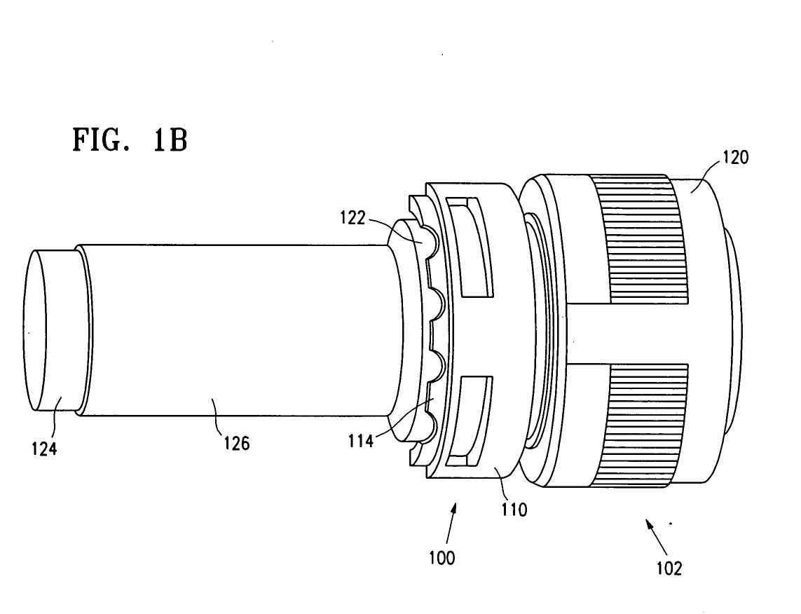

FIG. 1A is a perspective view of a backshell device 100 coupled to a connector 102 via a securing member 104. Connector 102 includes a wiring harness 124 and an overbraid or shielding sock 126 that overlies wiring harness 124.

Backshell device 100 includes a mounting section 110 and a removable extension section 112. Removable extension section 112 extends from mounting section 110 and attaches thereto via separation features 114. In one embodiment, mounting section 110 and removable extension section 112 are semi-cylindrical. In another embodiment, mounting section 110 and removable extension section 112 comprise a lightweight material including a composite material, a metallic material, a metallic composite material, or various lightweight combinations thereof.

Connector 102 includes a housing 120 having a receiving section 122 extending therefrom. In one embodiment, housing 120 and receiving section 122 of connector 102 are cylindrical, and are adapted to receive the semi-cylindrical shape of mounting section 110 and removable extension section 112 of backshell device 100. It should be appreciated by those skilled in the art that connector 102 may comprise a male type of connector, a female type of connector, a plug type of connector, or a receptacle type of connector. Moreover, connector 102 may comprise an electrical connector or various other generally known type of connectors without departing from the scope of the present invention.

As shown in FIG. 1A, mounting section 110 of backshell device 100 overlies and couples to receiving section 122 of connector 102, and securing member 104 is positioned around mounting section 110 and secures mounting section 110 of backshell device 100 to receiving section 122 of connector 102. In one embodiment, securing member 104 comprises a band or bandit formed of various types of high strength materials, such as composite materials and various types of metal, such as, for example, stainless steel, aluminum, magnesium, and titanium.

As shown in FIG. 1A, receiving section 122 of connector 102 includes a first recessed groove 130 that receives securing member 104 of backshell device 100. In one embodiment, first recessed groove 130 includes a knurled surface. In general, the knurled surface of first recessed groove 130 may comprise various geometrical patterns and shapes, including diamond, rectangular, triangular, etc., without departing from the scope of the present invention. Moreover, receiving section 122 of connector 102 includes a second recessed groove 132 adjacent to first recessed groove 130 that receives lip feature 140 of mounting section 110 of backshell device 100 to secure backshell device 100 to connector 102 and inhibit slippage of backshell device 100 from connector 102.

In one aspect, as shown in FIG. 1A, securing member 104 clamps overbraid or shielding sock 126 and/or wiring harness 124 directly to mounting section 110 of backshell device 100 and receiving section 122 of connector 102 with 360° uniform pressure. It should be appreciated by those skilled in the art that, wherever lightening strike or EMI are concerned, this securing technique of securing member 104 provides an improvement in shielding.

As shown in FIG. 1B, removable extension section 112 of backshell device 100 can be separated from mounting section 110 of backshell device 100 by cutting separation features 114. In one embodiment, a portion of backshell device 100 can be removed when removable extension section 112 is separated from mounting section 110. For example, approximately 65% of backshell device 100 can be removed when removable extension section 112 is separated from mounting section 110. In general, the weight of backshell device 100 can be reduced when removable extension section 112 is separated from mounting section 110, which can provide significant weight savings. Without departing from the scope of the present invention, it should be appreciated by those skilled in the art that the length of the removable extension section 112 can be lengthened or shortened to accommodate various types and sizes of wiring harnesses 124 with or without the inclusion of overbraid 126.

Referring to FIGS. 1A and 1B, connector 100 includes wiring harness 124 that extends from receiving section 122 of housing 120. In one embodiment, wiring harness 124 can be secured to removable extension section 112 of backshell device 100 via at least one tie wrap 116, such as a plastic tie wrap including high temperature tie wraps, to provide strain relief to wiring harness 124. In addition, wiring harness 124 may include overbraid or shielding sock 126 that shields wiring harness 124 from external interference, such as high frequency communication signals and white noise. In general, wiring harness 124 comprises one or more wires, such as a group of wires. It should be appreciated by those skilled in the art that overbraid 126 is optional, and backshell device 100 can be mounted to connector 102 with or without overbraid 126.

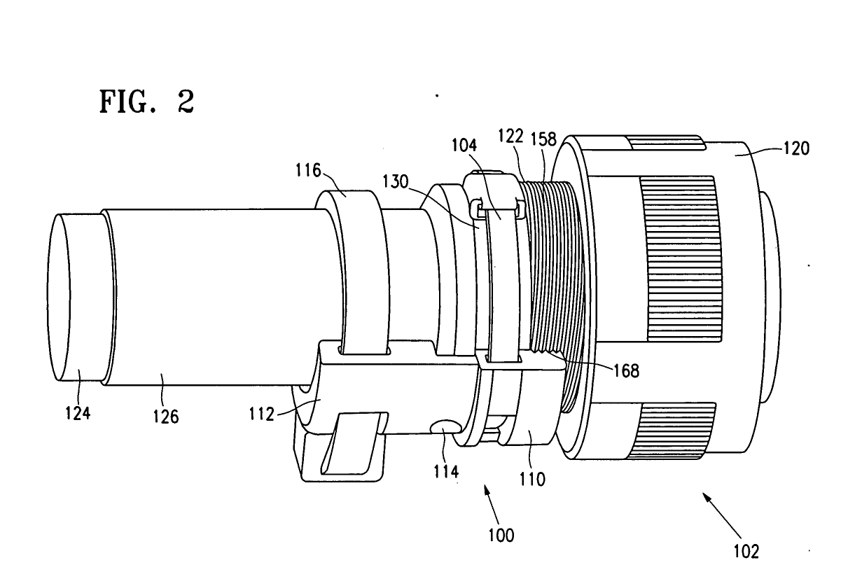

FIG. 2 is a perspective view of backshell device 100 coupled to connector 102 via securing member 104 and a threaded interconnection 158, 168. As with FIG. 1A, connector 102 includes wiring harness 124 and overbraid 126 that overlies wiring harness 124. In one embodiment, as shown in FIG. 2, receiving section 122 of connector 102 includes a threaded outer surface 158 adjacent to first recessed groove 130 that interconnects to a threaded inner surface 168 of mounting section 110 of backshell device 100. This threaded interconnection between threaded outer surface 158 of connector 102 and threaded inner surface 168 of mounting section 110 secures backshell device 100 to connector 102 and inhibits slippage of backshell device 100 from connector 102.

In general applications, backshell device 100 secures and stabilizes wiring harness 124 to connector 102 by preventing movement of wiring harness 124 with respect to connector 102. In addition, mounting section 110 of backshell device 100 secures overbraid 126 to receiving section 122 of connector 102 with or without removable extension section 112. Moreover, in one aspect, securing member 104 provide 360 of pressure to the junction between mounting section 110 of backshell device 100 and receiving section 122 of connector 102.

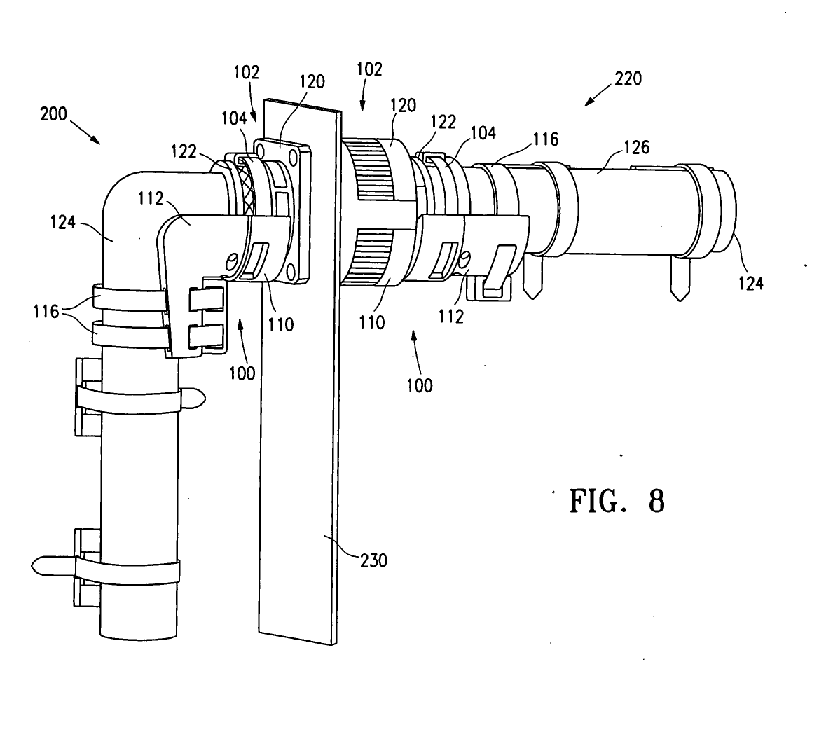

In some applications, backshell device 100 can be installed and coupled to connector 102 after connector 102 is already installed. As shown in FIGS. 1A and 8, since mounting section 110 and removable extension section 112 of backshell device 100 are semi-cylindrical, backshell device 100 can be coupled to receiving section 122 of connector 102 after connector 102 is already in an installed configuration, which can provide installation labor savings. Moreover, the semi-cylindrical shape provides a reduced size and footprint, which can reduce manufacturing costs.

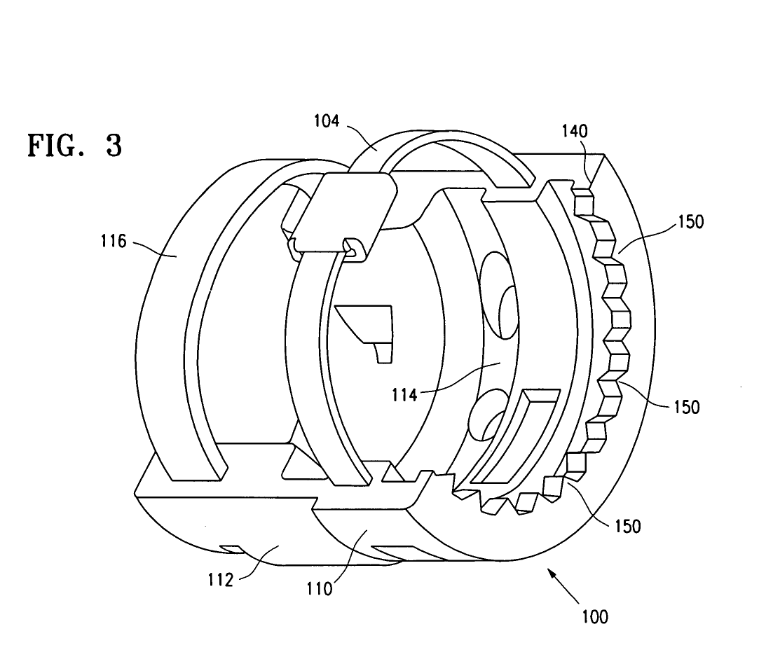

FIG. 3 is a perspective view of backshell device 100 having a plurality of first anti-rotation features 150 that protrude from an inner surface of lip feature 140 of mounting section 110. In one embodiment, first anti-rotation features 150 comprise protruding triangular teeth that are equally spaced apart along an inner arced surface of lip feature 140 of mounting section 100.

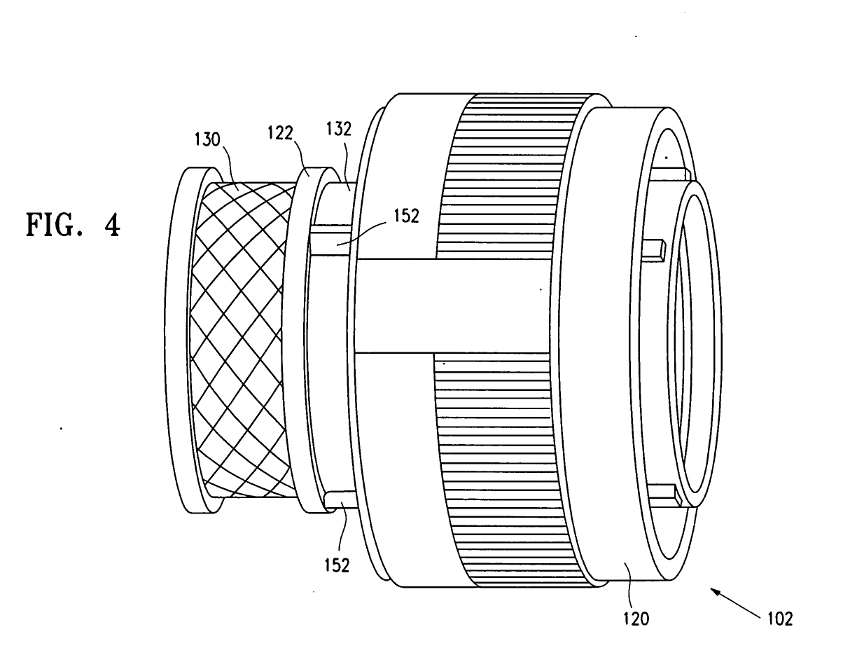

FIG. 4 is a perspective view of connector 102 having a plurality of second anti-rotation features 152 that protrude from a surface of second recessed groove 132 of receiving section 122. In one embodiment, second anti-rotation features 152 comprise protruding geometrical teeth that are equally spaced apart along the arced surface of second recessed groove 132 of receiving section 122. In a preferred embodiment, second anti-rotation features 152 comprise three protruding geometrical teeth that are equally spaced apart, at approximately 120°, around the circular surface of second recessed groove 132 of receiving section 122.

In one aspect of the present invention, second anti-rotation features 152 of connector 102 are shaped to receive and interconnect with first anti-rotation features 150 of backshell device 100. Moreover, first anti-rotation features 150 of mounting section 110 of backshell device 100 interconnect with second anti-rotation features 152 of second recessed groove 132 of connector 102 to secure position and inhibit rotation of backshell device 100 with respect to connector 102.

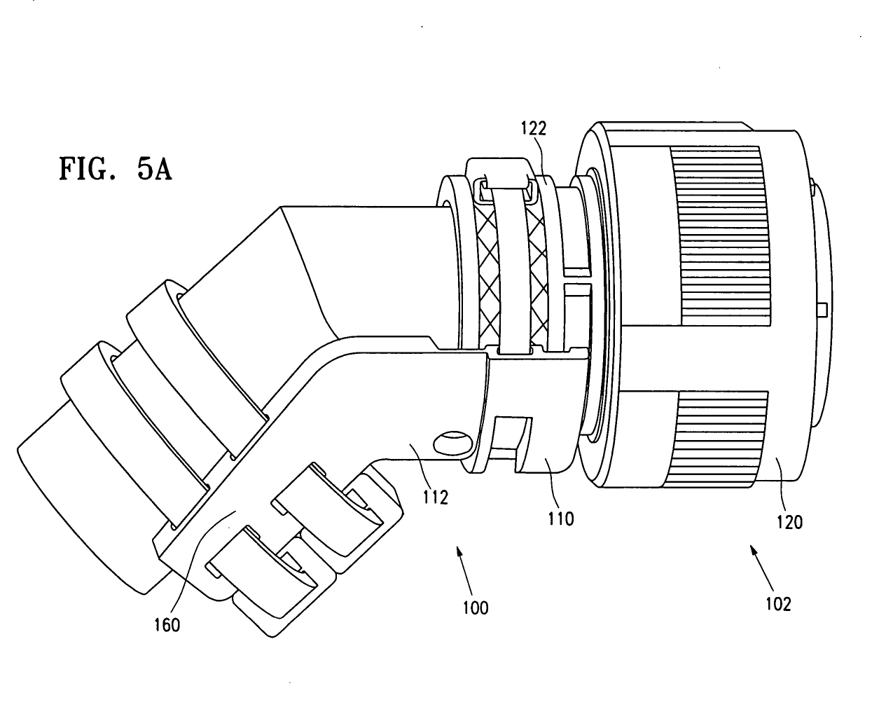

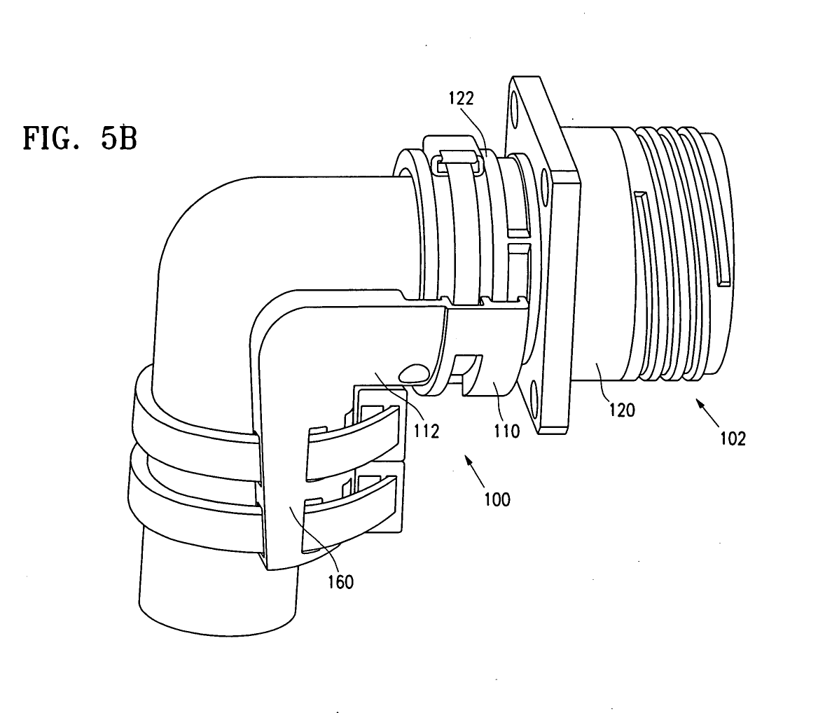

Referring to FIG. 1A, removable extension section 110 of backshell device 100 directly extends in a straight manner from mounting section 112. In one aspect, this straight extension of section 110 may be considered to extend at an angle, for example, of 0°. Alternately, FIGS. 5A and 5B are perspective views of backshell device 100 having an angled removable extension section 112. In one example, as shown in FIG. 5A, a portion 160 of removable extension section 112 may extend from mounting section 110 in an angular manner at an angle of 45°. In another example, as shown in FIG. 5B, portion 160 of removable extension section 112 may extend from mounting section 110 in an angular manner at an angle of 90°.

In general, it should be appreciated by those skilled in the art that portion 160 of removable extension section 112 may extend from mounting section 110 of backshell device 100 at any angle between 0° and 90° or 0° and 180° without departing from the scope of the present invention. Moreover, it should be appreciated by those skilled in the art that connector 102 may comprise a female type connector, as shown in FIG. 5A, or a male type connector, as shown in FIG. 5B, without departing from the scope of the present invention.

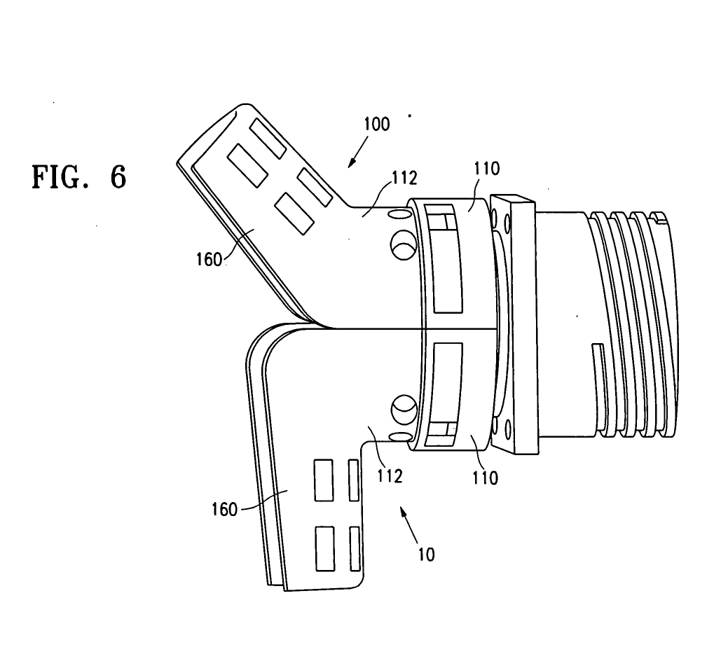

FIG. 6 is a perspective view of backshell device 100 having multi-exit features and capabilities for a plurality of wiring harnesses 124. In one embodiment, as shown in FIG. 6, secured cables can exit from a plurality of backshell devices 100 in a plurality of directions, including, for example, a 45° direction and a 90° direction. It should be appreciated by those skilled in the art that various other multi-directional configurations of the plurality of backshell devices 100 may also include 90°/90°, 45°/45°, straight/90° and straight/45° by using at least two backshell devices 100 and splitting at least two exiting wiring harnesses 124 in at least two different directions. This unique feature of the present invention facilitates connector to connector cabling or “daisy chaining” especially in a 90°/90° “T” type of configuration.

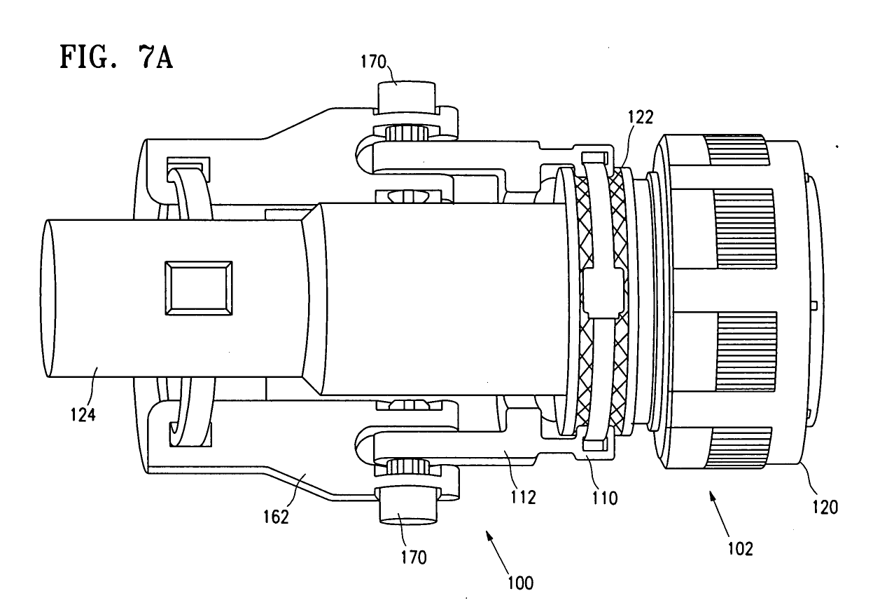

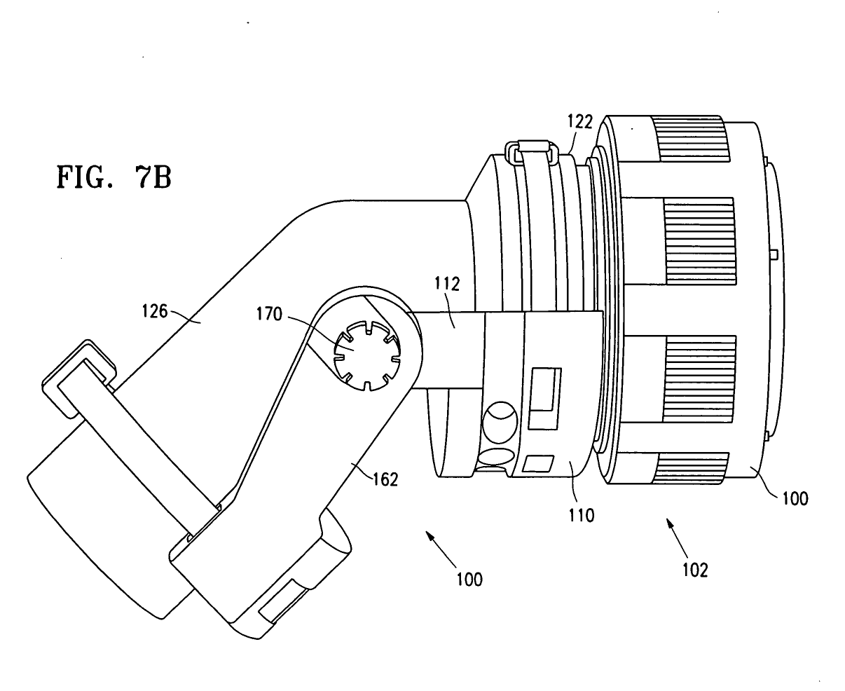

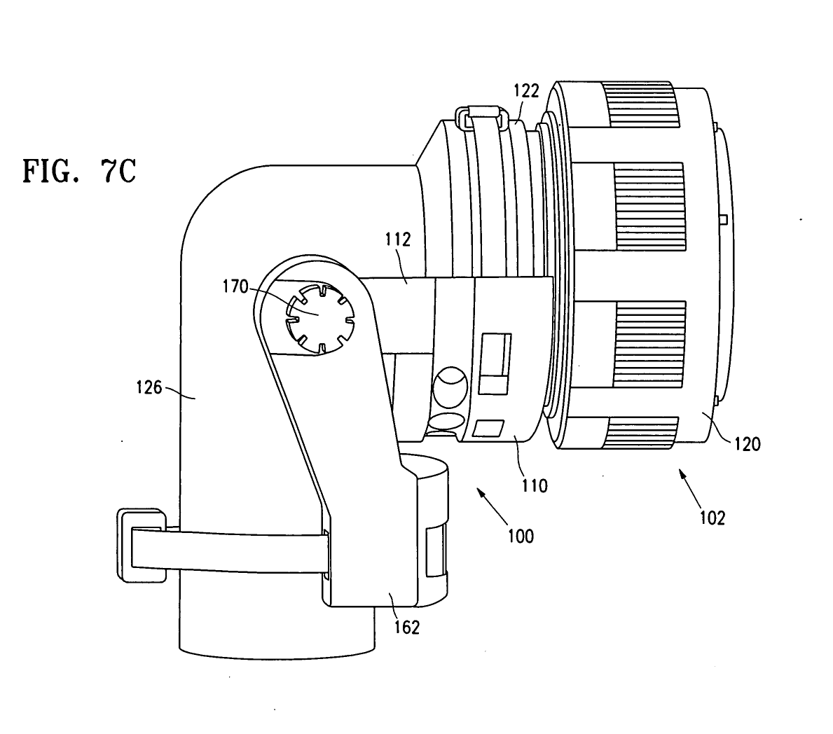

FIGS. 7A-7C are perspective views of backshell device 100 having removable extension section 112 with a pivotable portion 162. As shown in FIG. 7A, removable extension section 112 may include one or more selectable pivot features 170 that allows pivotable portion 162 of removable extension section 112 to pivot at an angle between 0° and 90° or 0° and 180° to accommodate various types of wiring harnesses 124 with or without overbraid 126.

As shown in FIG. 7A, pivotable portion 162 of removable extension section 110 can be positioned to directly extend in a straight manner from mounting section 112 at an angle, for example, of 0°. Alternately, as shown in FIG. 7B, pivotable portion 162 of removable extension section 112 may extend from mounting section 110 in an angular manner at an angle, for example, of about 45°. Additionally, as shown in FIG. 7C, pivotable portion 162 of removable extension section 112 may extend from mounting section 110 in an angular manner at an angle, for example, of about 90°. In general, it should be appreciated by those skilled in the art that pivotable portion 162 of removable extension section 112 may extend from mounting section 110 of backshell device 100 at any angle between 0° and 90°or 0° and 180° without departing from the scope of the present invention.

FIG. 8 is a perspective view of one example of an application of backshell device 100 and connector 102 of the present invention. As shown in FIG. 8, a first backshell assembly 200 includes backshell device 100 with a 90° angled removable extension section 112, and a second backshell assembly 220 includes backshell device 100 with a straight (0° angled) removable extension section 112. In addition, first backshell assembly 200 includes a connector 102 having a male type connector, and second backshell assembly 220 includes connector 102 having a female type connector. As shown in FIG. 8, male type connector 102 of first backshell assembly 200 is interconnected to female type connector 102 of second backshell assembly 220 through a wall or partition wall 230.

In general, backshell device 100 secures and stabilizes wiring harness 124 to connector 102 with full-functional performance by preventing movement of wiring harness 124 with respect to connector 102. In addition, mounting section 110 of backshell device 100 secures overbraid 126 to receiving section 122 of connector 102 with or without removable extension section 112. Moreover, mounting section 110 and removable extension section 112 are semi-cylindrical. This allows backshell device 100 to be installed after connector 102 is installed, which can provide installation labor savings. In addition, the semi-cylindrical shape provides a reduced size and footprint, which can reduce manufacturing costs.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

1. A backshell device for a connector comprising:
a mounting section coupled to a portion of the connector;
a removable extension section extending from the mounting section and attached to the mounting section via separation features; and
a securing member positioned around the mounting section for securing the mounting section to the connector.

2. The backshell of claim 1, wherein the connector includes a housing having a receiving section extending therefrom, and wherein the mounting section of the backshell device couples to the receiving section of the connector.

3. The backshell of claim 2, wherein the securing member is positioned around the mounting section of the backshell device and the receiving section of the connector to secure the backshell device to the connector.

4. The backshell of claim 2, wherein the receiving section of the connector includes a first recessed groove that receives the securing member of the backshell device.

5. The backshell of claim 4, wherein the receiving section of the connector includes a threaded portion adjacent to the recessed groove that couples to a threaded portion of the mounting section of the backshell device.

6. The backshell of claim 4, wherein the first recessed groove includes a knurled surface.

7. The backshell of claim 2, wherein the mounting section includes anti-rotation features that protrude from an inner surface of the mounting section.

8. The backshell of claim 7, wherein the receiving section of the connector includes a second recessed groove adjacent to the first recessed groove that couples with the anti-rotation features of the mounting section of the backshell device to thereby inhibit rotation of the backshell device with respect to the connector.

9. The backshell of claim 1, wherein the mounting section and the removable extension section are semi-cylindrical.

10. The backshell of claim 1, wherein the removable extension section is separated from the mounting section by cutting the separation features.

11. The backshell of claim 10, wherein 65% of the backshell device is removed when the removable extension section is separated from the mounting section.

12. The backshell of claim 1, wherein the mounting section and the removable extension section comprises a lightweight composite material.

13. The backshell of claim 2, wherein the connector includes a wiring harness that extends from the receiving section of the housing, and wherein the wiring harness is secured to the removable extension section of the backshell device via at least one tie wrap to thereby provide strain relief to the wiring harness.

14. The backshell of claim 13, wherein the wiring harness includes an overbraid that shields the wiring harness.

15. The backshell device of claim 1, wherein a portion of the removable extension section extends from the mounting section at an angle between 0° and 90°.

16. The backshell device of claim 1, wherein a portion of the removable extension section extends from the mounting section at a 45° angle.

17. The backshell device of claim 1, wherein a portion of the removable extension section extends from the mounting section at a 90° angle.

18. The backshell device of claim 1, wherein the removable extension section includes a selectable pivot feature that allows a portion of the removable extension section to pivot at an angle between 0° and 90°.

19. The backshell device of claim 1, wherein the connector comprises a male or female connector.

20. A backshell assembly comprising:
a connector;
a backshell device having a mounting section that couples to a portion of the connector, the backshell device having a removable extension section extending from the mounting section and attached to the mounting section via separation features; and
a securing member positioned around the mounting section for securing the mounting section to the connector.
